(19) United States
(12) Patent Application Publication
(10) Pub. No.: US 2025/0225338 A1
(43) Pub. Date: Jul. 10, 2025

(54) REAL-TIME LANGUAGE TRANSLATION SYSTEMS EMBODIED IN A PHYSICAL DEVICE

(71) Applicant: myLanguage, Inc., Meadow Vista, CA (US)

(72) Inventors: Andrew Nelthropp Lauder, Meadow Vista, CA (US); Damien Marcus Dalli, Mission Viejo, CA (US); Daniel Joseph Yerelian, Rancho Palos Verdes, CA (US); Robert Franklin Ross, Santa Ana, CA (US)

(21) Appl. No.: 19/014,171

(22) Filed: Jan. 8, 2025

Related U.S. Application Data
(60) Provisional application No. 63/618,524, filed on Jan. 8, 2024.

(51) Int. Cl. G06F 40/40

(52) U.S. Cl. CPC G06F 40/40

(57) ABSTRACT

The present disclosure provides a real-time language translation system embodied in a physical device. Further, the real-time language translation system may include an input device which may be configured for receiving generating a user input data representing a linguistic input from a user. Further, the linguistic input corresponds to a user language. Further, the real-time language translation system may include a processing device which may be configured for generating a translation data based on the user input data. Further, the translation data represents a translation of the linguistic input. Further, the generating may be based on an AI module. Further, the processing device may be communicatively coupled to the input device. Further, the real-time language translation system may include a presentation device which may be configured for presenting the translation data. Further, the presentation device may be communicatively coupled to the processing device.

The current application claims a priority to the U.S. provisional patent application Ser. No. 63/618,524 filed on Jan. 8, 2024.

### FIELD OF THE INVENTION

The present disclosure relates to the field of data processing. More specifically, the present disclosure relates to a real-time language translation system embodied in a physical device.

### BACKGROUND OF THE INVENTION

Current translation systems often struggle with accuracy and context, leading to misinterpretations. These systems typically rely on outdated databases that lack the nuances of ever-evolving languages and regional dialects, failing to keep up with cultural shifts. Moreover, many existing systems are limited in their real-time translation capabilities, making live conversations ineffective. They often do not support the wide range of languages and dialects necessary for truly global communication. Therefore, there is a need for improved real-time language translation systems embodied in a physical device.

### SUMMARY OF THE INVENTION

This summary is provided to introduce a selection of concepts in a simplified form, which are further described below in the Detailed Description. This summary is not intended to identify key features or essential features of the claimed subject matter. Nor is this summary intended to be used to limit the claimed subject matter's scope.

The present disclosure provides a real-time language translation system embodied in a physical device. Further, the real-time language translation system may include an input device which may be configured for receiving generating user input data representing a linguistic input from a user. Further, the linguistic input corresponds to a user language. Further, the real-time language translation system may include a processing device which may be configured for generating translation data based on the user input data. Further, the translation data represents a translation of the linguistic input. Further, the generating may be based on an AI module. Further, the processing device may be communicatively coupled to the input device. Further, the real-time language translation system may include a presentation device which may be configured for presenting the translation data. Further, the presentation device may be communicatively coupled to the processing device.

The present disclosure provides a real-time language translation system embodied in a physical device. Further, the real-time language translation system may include an input device which may be configured for receiving generating user input data representing a linguistic input from a user. Further, the linguistic input corresponds to a user language. Further, the real-time language translation system may include a processing device which may be configured for generating translation data based on the user input data. Further, the translation data represents a translation of the linguistic input. Further, the generating may be based on an AI module. Further, the processing device may be communicatively coupled to the input device. Further, the real-time language translation system may include a presentation device which may be configured for presenting the translation data. Further, the presentation device may be communicatively coupled to the processing device. Further, the physical device may be configured to be affixed on a user device associated with the user. Further, the physical device may be configured to be communicatively coupled to the user device. Further, the physical device includes one or more of a mobile case and an enclosed backpack.

The present disclosure provides a real-time language translation system embodied in a physical device. Further, the real-time language translation system may include an input device which may be configured for receiving generating user input data representing a linguistic input from a user. Further, the linguistic input corresponds to a user language. Further, the real-time language translation system may include a processing device which may be configured for generating translation data based on the user input data. Further, the translation data represents a translation of the linguistic input. Further, the generating may be based on an AI module. Further, the processing device may be communicatively coupled to the input device. Further, the real-time language translation system may include a presentation device which may be configured for presenting the translation data. Further, the presentation device may be communicatively coupled to the processing device. Further, the real-time language translation system may include a storage device which may be configured for storing each of the user input data and the translation data associated with the user input data.

The speech data represents a word spoken by the user. Further, the noise data represents the audio data excluding the speech data. Further, the two or more AI modules include a voice activity detection AI module which may be configured for detecting the speech data from the audio data. Further, the detection may be based on the audio characteristic data associated with the audio input.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a block diagram of a real-time language translation system 300 embodied in a physical device, in accordance with some embodiments.

FIG. 4 illustrates a block diagram of the real-time language translation system 300 embodied in a physical device, in accordance with some embodiments.

FIG. 5 illustrates a block diagram of a presentation device 306 included in the real-time language translation system 300 embodied in a physical device, in accordance with some embodiments.

FIG. 6 illustrates a block diagram of the real-time language translation system 300 embodied in a physical device, in accordance with some embodiments.

FIG. 7 illustrates a block diagram of the real-time language translation system 300 embodied in a physical device, in accordance with some embodiments.

FIG. 8 illustrates a block diagram of the real-time language translation system 300 embodied in a physical device, in accordance with some embodiments.

FIG. 9 illustrates a translator case design showing Phase 1 vs. Phase 2 designs side-by-side.

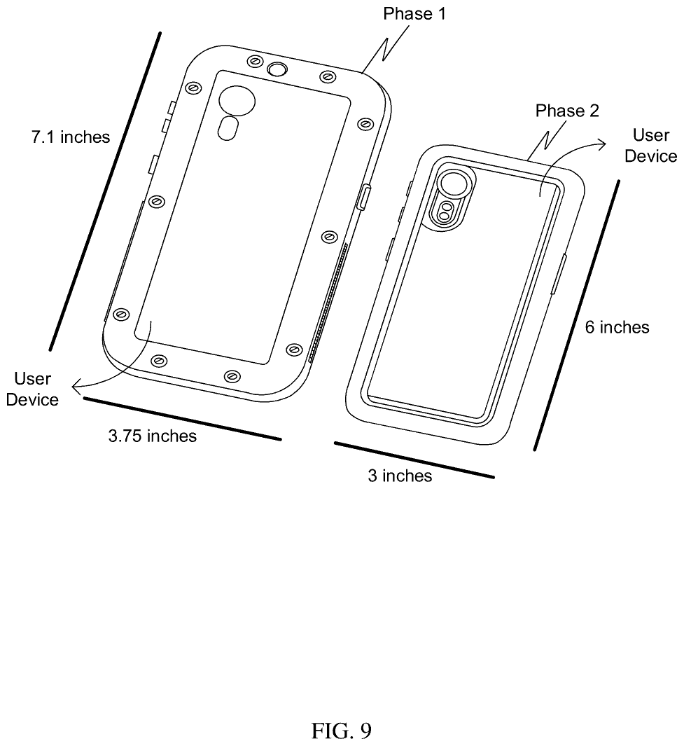

FIG. 10 illustrates a translator case design showing Phase 1 vs. Phase 2 designs side-by-side.

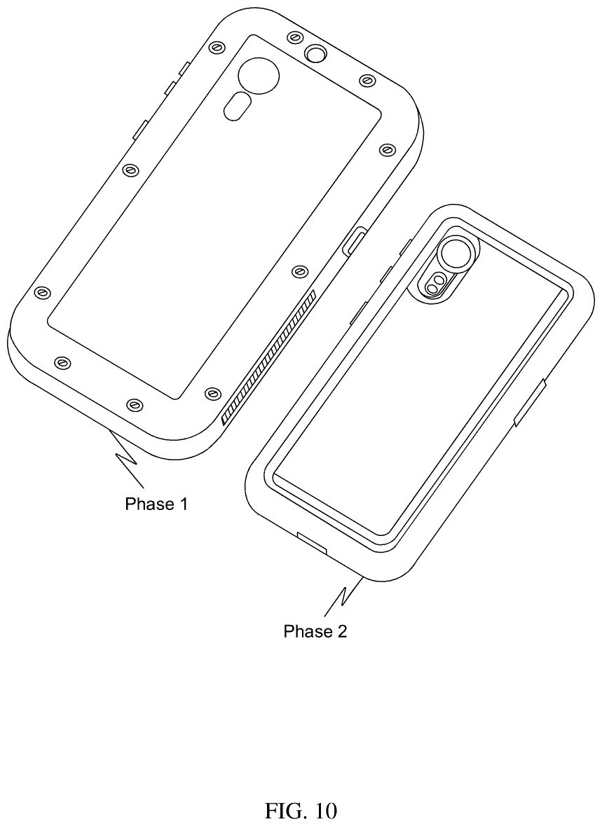

FIG. 11 illustrates a translator case design showing Phase 2 “bubble with bumper” design.

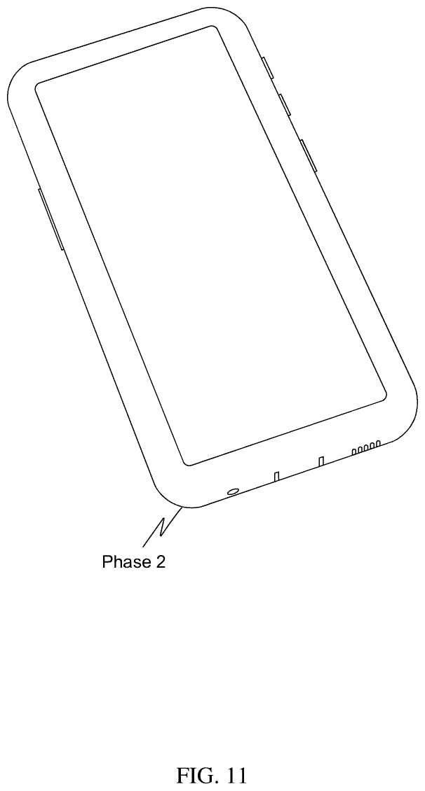

FIG. 12 illustrates a translator case design showing Phase 2 vs. Phase 1 designs side-by-side.

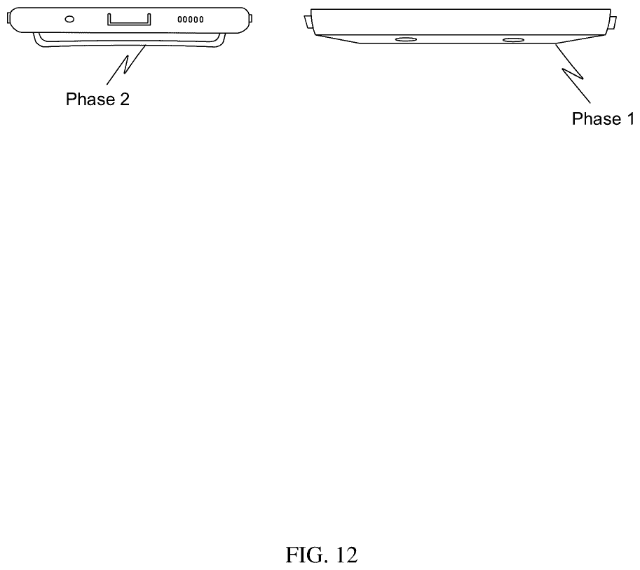

FIG. 13 illustrates a translator case design showing Phase 2 vs. Phase 1 designs side-by-side.

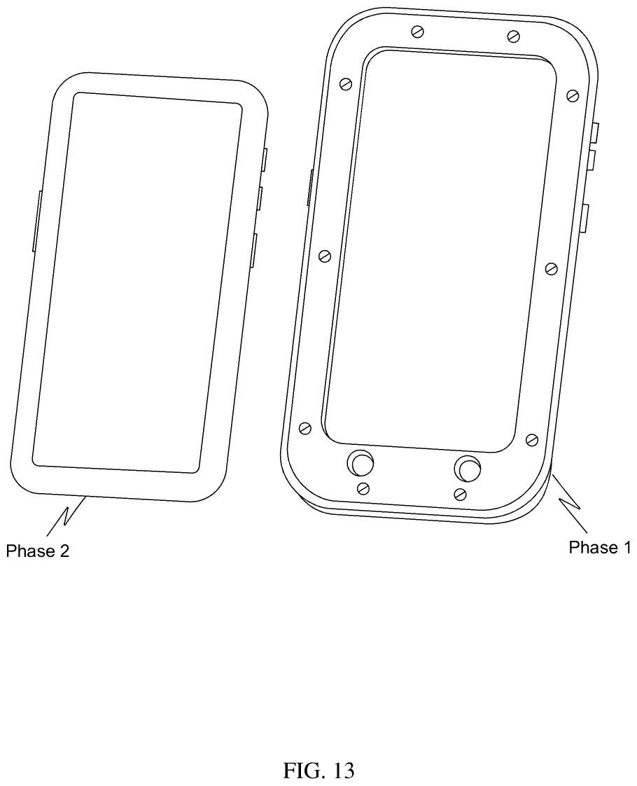

FIG. 14 illustrates a translator case design showing Phase 3 “enclosed backpack” design.

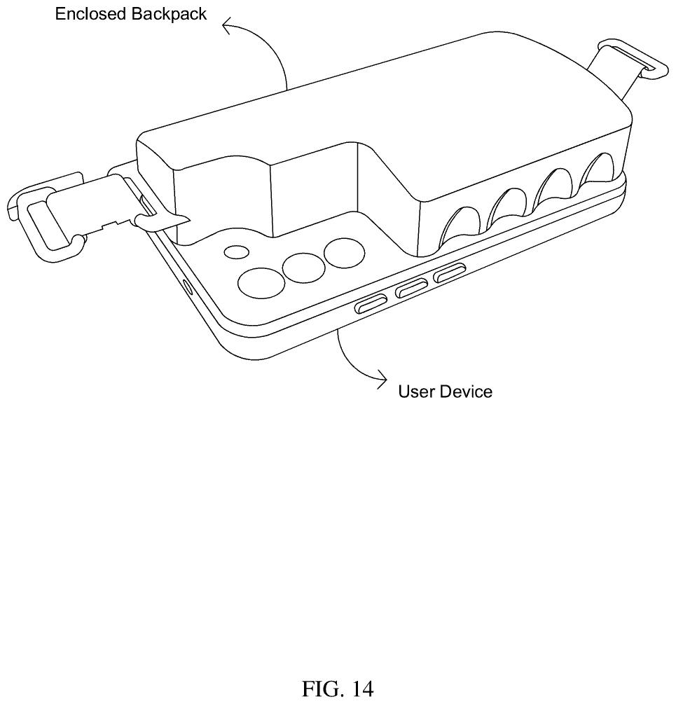

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denote “at least one” but do not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, a mini-computer, a micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

Artificial Intelligence is a broad term that refers to any approach to making computers or machines exhibit behaviors that can be described as “intelligent”. Within this field, one of the most popular approaches to developing intelligent systems is known as “Machine learning”. Machine learning refers to the use of algorithms, called “models”. that have a number of initially unspecified parameters. These parameters are initialized using different methods that can vary depending on the nature of the model. Common initialization methods include setting all parameters to 0 or setting them to random values pulled from some statistical distribution, such as a normal distribution with mean 0 and standard deviation of 1. These models are then subjected to a process known as “training” where inputs from a training data set are run through the algorithm and compared with a desired output. This desired output is then compared to the algorithm's output by using a loss function which, given the desired and actual model output, calculates a numerical value (conceptually a real number, but in practice typically represented by a floating-point value) that represents how bad the model's output was. It is then possible to calculate the derivative of this value with respect to every parameter and make a small change to the parameter based on the derivative, which will often result in a better outcome when repeating this process. The training process then repeats using different data until a stopping point is reached. When this process is done with several different data elements (or “samples”) in parallel this is called a “batch”. Performing some number of batches such that each sample in the full set of training data is used exactly once is called an “epoch”.

One of the most popular approaches to structuring machine learning models is to use an Artificial Neural Network (ANN), sometimes also called just a “Neural Network” or an “ANN”. A machine learning model is said to be an ANN when it is structured in a way that is loosely based on the communication of neurons in the human brain. This means forming a directed graph where the nodes represent numerical values, and the edges represent information flow from one node to another. The inputs to the ANN are source nodes in the graph and the outputs are the sink nodes in the graph. Each node is computed as a nonlinear function of a weighted sum of its direct predecessors. This computation is ordered such that a node is not computed until after all of its direct predecessors have been computed. A node in this graph can be considered to belong to a layer of nodes. All nodes which have the same length for their longest path from a source node belong to the same layer.

The area of research known as “Natural Language Processing” has been active for many years. This is a broad area of study that includes approaches to perform many distinct but related tasks. Many of these tasks have associated published algorithms and source code for artificial neural networks that can perform these tasks.

At a high level, the major categories of algorithms relevant to a translation system are voice activity detection, speech recognition, tokenization, machine translation, text-to-speech, speaker identification, and language identification. State-of-the-art performance on all of these tasks is achieved through the use of artificial neural networks.

Voice Activity Detection (VAD) is a technology used in speech processing to detect the presence or absence of human speech in an audio signal. It's a critical component in various applications, such as speech recognition, telecommunications, and voice assistants.

VAD algorithms analyze audio signals to distinguish between speech and non-speech segments. They use various features of the audio signal, such as energy, frequency content, and temporal patterns, to make this distinction. The goal is to accurately identify when someone is speaking and when they are not, even in the presence of background noise or other sounds.

Simple VAD systems might look at the energy levels of the audio signal. Speech generally has higher energy levels than silence or background noise.

More advanced systems analyze the frequency spectrum of the audio. Human speech has characteristic spectral patterns that can be detected.

Some VAD systems use statistical models like Hidden Markov Models (HMMs) or neural networks to more accurately differentiate speech from other noises or silence.

Speech recognition is also called Automatic Speech Recognition (ASR) or Speech-to-Text (STT). The inputs to these models can be raw audio data, or more commonly a transformation of raw audio data into another format such as a spectrogram. The output of these models is typically a series of phonemes, letters, or tokens. This output can then be readily turned into a transcript of the spoken words by converting the output series into normal text.

Audio data, raw or processed, can also be used for other classification problems. This includes speaker identification and language identification. One common way of creating these models is to combine two other parts or sub-models that can each be considered as a model. The first takes the audio input and generates a collection of numbers (a “vector”) that is often called a vector embedding. The second part either takes this vector and outputs a probability that the original data came from a set of predefined classes (i.e., speakers or languages), or it takes two vectors as input and outputs a probability that the two vectors both originated from the same class (i.e., are both the same speaker or the same language).

Tokens are often used in language processing models as a convenient representation of text. Tokenization is the expression of text in terms of a series of these tokens. Generally, a “token” refers to a common series of letters that occur together in a language, such as “ist” or “pre” in English. This allows a model to work directly with common prefixes, suffixes, or infixes without needing to model individual letters. Most state-of-the-art models working with textual language use tokens that vary in the length of the represented text and may represent a single letter, a whole word, or something between the two. Tokens may also differ based on their position within a word, for example “the me” and “theme” may both be converted to a series of two tokens, but “the” and “the” may be considered distinct tokens in the encoding. Conversion from a sequence of tokens to text is performed by simply concatenating the textual representation of each token in order.

Machine translation is the task of translating text from one language into another. Neural Machine Translation (NMT) refers to the use of Artificial Neural Networks (ANNs) to perform the task of machine translation.

Speech synthesis is also called Text-to-Speech (TTS). This is the reverse of speech recognition. This is the task of converting phonemes, letters, or tokens into audio data that can be played through a speaker and understood by a person listening to the synthesized speech.

Many of these tasks share in common that the input and output of the task are both sequences. For example, in a typical audio-to-audio translation process, ASR converts a sequence of sounds to a sequence of tokens. NMT converts a sequence of tokens in one language to a sequence of tokens in another language. TTS converts a sequence of tokens into a sequence of sounds. These models collectively are all referred to as “Seq2seq” (short for “sequence to sequence”) models because they convert one sequence to another. It's also possible that Seq2seq models can directly convert an audio sequence in one language to an audio sequence in another language.

Seq2seq models are typically conceptually split into an encoder and a decoder. The purpose of the encoder is to convert the input sequence into a form that represents the important details in a way that can be used efficiently by the decoder. Once the encoder has run, the decoder generates the output sequence one element at a time. Given the outputs of the encoder and any previous outputs of the decoder, the decoder forms a probability distribution over the next possible elements of the output sequence. This probability distribution can be defined and sampled in various ways, and the results of sampling this distribution are how the next element is selected. The decoder is then run again with the newly generated element included. This process repeats until the decoder eventually outputs an element that indicates it has reached the end of the sequence, at which point the output sequence is complete.

Output element distributions from seq2seq models are most commonly defined by one numerical output for each possible element (e.g., tokens). These raw numbers (+) are turned into a probability distribution (pᵢ) over n possibilities using the softmax function:

$${p}_{i} = \frac{exp ( {x}_{i} )}{{\sum }_{j = 1}^{n} exp ( {x}_{j} )}$$

Common modifications of the softmax function are top-k, top-p, or temperature-based sampling.

Temperature based sampling is a modification of softmax that chooses some T>0 called the temperature and computes the probability distribution as:

$${p}_{i} = \frac{exp ( \frac{{x}_{i}}{T} )}{{\sum }_{j = 1}^{n} exp ( \frac{{x}_{j}}{T} )}$$

Top-k sampling takes the probability distribution and selects the largest k: <n probabilities. These probabilities are then renormalized to sum to 1 while all other values are treated as 0. Thus, the final sampling is taken from a probability distribution of only k possibilities.

Top-p sampling, also known as Nucleus Sampling, chooses some q<P as the size of the “nucleus”, and finds the smallest set of elements with probabilities that sum to at least q. These probabilities are then renormalized to sum to 1 while all other values are treated as 0.

Beam search is a related technique where in some instances more than one possible selection is made from the probability distribution for the next element in the sequence. This may vary from considering every possibility, considering all of the top possibilities, or considering the top k possibilities out of a nucleus determined by nucleus sampling. Beam search effectively creates a tree of elements by branching at each point where more than one possibility is selected. This results in an output that contains a number of distinct sequences where each sequence represents one path from the root of the tree to a leaf of the tree where the sequence terminates.

Perplexity is a measure of uncertainty in a probability distribution. In the case of machine translation models, this can be used to describe the uncertainty regarding the correct translation. In this context it can also be viewed as a measure of the information gained from learning the correct translation, specifically the exponentiation of the entropy. Perplexity of a probability distribution pᵢ can be computed as:

$${\prod }_{i = 1}^{n} {p}_{i}^{- {p}_{i}}$$

Traditional speech-to-speech translation systems employ a cascading architecture, where each step of the process (speech to text, text to text translation, translated text to synthesized speech) loses information, because the model only returns the highest scored result for each step. Modern speech-to-speech translation systems use an end-to-end architecture, where speech input is converted into translated speech output, in one step, without any intermediate steps. The benefit of an end-to-end speech translation system is that it does not lose information because it is a single process. The downside of end-to-end is the inability to see the output at each step.

### Real-Time Translation

Embodiments of real-time language translation between languages are described herein. In various embodiments, the input to a real-time language translation system can be voice or text in a first language and the output from the system can be text and/or voice in a second language. As will be described in detail below, various embodiments of the real-time translation system leverage user interfaces, the option to link different devices, error and ambiguity reduction, language and dialect detection, user provided corrections, protection of translated chat history, among other features, to provide accurate and efficient translation between different languages.

### Physical Device

In various embodiments, the real-time language translation solution or system (which is sometimes referred to as the “myLanguage™ Translation solution”) can be implemented in physical devices. The design of the physical device may vary depending on the operating system (e.g., Android and iOS) that is running on handheld devices with which it will be compatible. These are convenient as they can be carried around and used in various environments where person-to-person communication is appropriate. The various physical devices can also be hardened and adapted to suit their environments. For example, a physical device that is adapted for maritime use would have a buoyant component. This involves selecting an appropriate hardware platform and customizing an enclosure and flotation device. See the Images below.

The five images above show example physical devices with example dimensions. As shown in the images above, the physical device can be added to a mobile/handheld device as a case and also provides floatation capabilities to the device. Floatation capabilities can be provided by buoyant materials or air within the case in volumes that would be sufficient to float the attached device. The Archimedes Principle defines the buoyant force needed to float an object.

The image above shows another example of the physical device in which the physical device can be attached to a buoyant component.

While not shown in an image, another example of the physical device is a standalone device that has buoyant material built into the device structure.

In some embodiments, to interact with the physical device, the user taps a button on the screen (or a hardware button) to initiate recording, or the device is in listening mode, waiting for speech. For example, when input speech is heard, the physical device detects the input language, transcribes the input language into text. When the physical device detects the end of speech, the physical device translates the text into text of the output language, synthesizes the output text into speech, and plays the audio through the speakers.

In some embodiments, to interact with the physical device, the user can either speak directly into the device, into a connected (e.g., via Bluetooth) device, or if the device is connected to other translation devices, the speech can be captured and transmitted over the Wifi Direct connection, as described below.

Furthermore, the real-time language translation system can be deployed in a variety of systems and platforms. In some embodiments, the real-time language translation system can be implemented as software (e.g., an application) that is downloaded onto a device and that is executed by one or more hardware processors of the device. Anywhere, verbal and written communication is ingested and transmitted. These include mobile and wearable devices, embedded into systems such as 911 and VHF radios as well as implemented on desktop computers to interface and piggyback on Windows, macOS, and Linux/Unix operating systems.

### Device-to-Device Translation

In various embodiments, the real-time language translation system can be used to connect distinct devices to enable the translation of input text/voice into output text/voice across devices. Each of such devices can be used by a single speaker or group of speakers. This is most commonly used with two speakers using two distinct devices but can be extended to groups of any number of speakers and devices. This translation process can occur on devices such as a mobile device, a laptop, a desktop computer, or the physical device such as described above. For example, speakers/users of different devices and that speak/type different languages can use a first device to input text/voice in a first language to effect the translation of that input into text/voice in a second language to be output at a second device.

In some embodiments, when a user speaks or types into their device, the content of their input speech is sent to the other devices participating in the same conversation. In some embodiments, the input speech data may be sent as, for example, raw audio data, a transformation of the audio data such as a Fourier transform, spectrogram, Mel-frequency cepstral coefficients (MFCCs), a vector embedding of the audio data or portion of the audio data generated by a machine learning algorithm, or as a text transcription of the original audio to the other connected target/output device(s). Other participants in the conversation receive this audio data or representation thereof and their device can locally translate it into the recipient's language, displaying text and/or playing synthesized audio speech for that recipient. In some other embodiments, the input speech is translated at the source device (the device into which the user had input the speech) into one or more output languages and the translated audio/text in the output language is sent to the connected device(s), at which the translated audio/text is output (e.g., on the display screen and/or through the speakers of the target device). How much of the translation steps are performed at the source device and at each of the target device(s) may vary depending on factors such as, the configuration (e.g., language pack availability, available processing resources) at the source/target devices and the stability of the connection between the source/target devices, for example. For example, where a target device is not configured (e.g., does not have the appropriate language packs) to perform the translation between the input language and the output language, then the source device can perform the translation and then send the translated audio/text product to the target device.

The following is a specific example of how the real-time translation system can perform translation of input speech/audio in a source language into speech/audio in a target language: the system collects audio data from the device microphone into a buffer in 16 kHz PCM format with 32-bit floating point values. As this data arrives, every 15600 samples (0.975 seconds) are passed through a VAD model which provides a binary classification of whether that audio window contains speech or not. When the VAD model classifies the audio data as containing speech, the translator begins to buffer audio from that point forward, including the time window that was initially detected as containing speech. While buffering this audio data, every 15600 samples another inference is performed with the VAD model until it classifies a time window as non-speech. This final window classified as non-speech is then the end of the audio buffer that was started at the first VAD speech detection. The exact size of the individual audio chunks may vary from 15600 samples in different implementations. The full audio buffer that was classified as speech then is run through a transcription model that uses an ASR model trained using Connectionist Temporal Classification (CTC). The output from the ASR model is trained using CTC Beam Search together with a language model to generate a text transcription of the audio data. This language model can optionally have the context or conversation history prepended to its input data to allow the generated probabilities to account for the prior context when assigning probabilities. This transcription is then tokenized to be passed through an NMT model that was trained for the specific pair of source and destination languages involved in the current translation. The output of this NMT model is then displayed in text form for the user to read. The tokenized output text is then passed through another NMT model which translates in the reverse direction and its output text is displayed for the original speaker to read as the “round-trip translation”, as will be described below, giving the speaker an idea of the translation accuracy. Finally, the translated text from the first NMT model is then given as the input to a TTS model which generates audio data of synthesized speech of the translated statement spoken in the translated language.

In some embodiments, a button may be selected by a user to indicate the start of input speech. When a button is used to indicate the start of speech, then pressing that button begins the process above with capturing audio data and classifying it with a VAD model. In some embodiments, a button does not need to be selected by a user to indicate the start of input speech. In modes where a button is not used to indicate the start of speech, the device is listening at all times when the app is running, allowing the VAD model to indicate the start of speech at any time. In some embodiments, where instances where speaker ID, language ID, or dialect ID models are used, the classification occurs just before passing the audio buffer through the ASR model. First, the speaker is identified using the techniques described in the “Automatic Speaker Identification” section below. If the speaker was not previously part of the conversation, that speaker is added to the conversation. After the speaker is identified either automatically or through manual input through the app (e.g., pressing the appropriate button in two button translation mode), then language ID can be performed as described in the “Language and Dialect Identification” section below. This language ID is associated with the speaker, replacing any previously associated language identification. Optionally, the speaker may be prompted to confirm the change in language. The speaker's associated language is used as the source language for the audio buffer being translated and will be used as the destination/target/output language for this speaker in this conversation until changed at a later time. Some modes of the application bypass speaker and/or language identification models by instead prompting the users to manually input the current speaker and their associated language.

In some embodiments, language or dialect identification can also be performed once at the start of a conversation after a language detection button has been pressed. In this mode of operation, the device will collect audio data in chunks, such as 2 second audio windows, for example, and pass each chunk to a language or dialect identification model. If two chunks in a row both identify the same language or dialect, then that is selected for use throughout the remainder of the conversation.

Knowledge of the original/input speech language may come from labels sent along with the speech data or may be associated with a particular user when the conversation is first established. Alternatively, the source language or dialect of the input speech data may be inferred using a neural network trained for language identification in order to allow speakers to change language during a conversation.

### WiFi Connect

In some embodiments, devices in a conversation can be connected by having a “host” device create a temporary Wifi network, sometimes called a “local”, “ad hoc”, or “peer to peer” network. The SSID and encryption key can be displayed on the host device in a human readable format and/or a QR code format. Other devices can join the conversation by being given information about the WiFi network and how to find the host device after joining the network. This includes the possibility of pointing the camera of the joining device at the QR code displayed on the host device.

### Connect Over the Internet, Local Network

In some embodiments, devices in a conversation can be connected by using the local network (Wifi or LAN), over the Internet, and over a radio communication. When devices are not on the same local network, they can use a relay service hosted on the internet. This service can allow a user to make a secure connection using TLS. For the user that is initiating the connection, their device will receive a connection identifier that can be shared with the other parties to the conversation. This identifier will allow those parties to make a secure TLS connection to the same internet service and exchange conversation data. This conversation data can take the form of text in the speaker's source language together with an identifier of that source language, for example, allowing each recipient's device to translate into their preferred language. While this text format makes efficient use of network connections it is also possible to transfer any earlier intermediate representation of the speaker's utterance, including full audio data, spectrograph data, MFCCs, vector embeddings of sentence meaning, numerical tokens of phonemes or numerical tokens representing the text transcription.

### Full Duplex

In various embodiments, Device-to-Device translation is done in a full duplex manner, allowing different participants to speak at any time and transmitting their speech data (or representation thereof) to other participants either in real-time or after a brief processing delay (e.g., of no more than a few seconds). Each participant in the conversation has a device which is expected to hear that participant more clearly than any other participant. Thus, when two speakers both speak at the same time (e.g., when overlapping speech is detected), each of their devices will buffer the appropriate audio data and generate the appropriate transcription simultaneously. When the transcription is ready to be transmitted, it will be communicated to the other target device(s), each of which will displays the translated text immediately and will then wait until the local speaker has stopped speaking before playing the synthesized speech of the translated text.

In some embodiments, if a user is disconnected during a conversation, they will be marked as no longer present in the conversation for other users. At this point, any pending audio or transcript data from that speaker will be discarded. A user may rejoin a conversation in progress at any time and if the conversation is configured to share history, then they will receive a full transcript of the conversation up until the point of them rejoining. The user may find that some speech was cut off or missing and will then have the option to repeat their statement as appropriate.

### No Button Interface

In some embodiments in which no button selection is required to initiate translation, a speaker is not required to press a button to indicate when their speech begins. Each device listens for speech from the associated speaker and subsequently transmits the speech data or representation thereof. This may be based simply on listening for the loudest or closest voice to the device or may additionally include the use of identifying characteristics in the speech to filter out background vocalizations from others.

### Headphone/Mic Accessory

Augmenting the device on which the real-time translation system is running with a headphone and microphone combination, including such hardware as earbuds (e.g., AirPods), can improve the user experience by avoiding outside noise interference with the synthesized speech and by improving the signal-to-noise ratio of the user's speech.

### Single Device Translation

In various embodiments, translation can occur on a single device that two or more speakers share. In some embodiments, where a single device is shared between two (or more) speakers, the screen of the device is split into sections that allow configuring the language to use for each speaker's side of the conversation. Each portion of the user interface of the real-time translation application then shows the conversation in that language and offers controls for the speaker(s) of that language to use.

For example, if the speaker does not know the name of the target language, they can tap the language detect button of the device, and the device will listen for speech, identify the language, transcribe the speech and translate the speech into the device's default or previously configured language (e.g., English for US Coast Guard, but could be any language).

For example, if the speaker knows the target language of the person they are trying to speak with, they can select that target language and then tap a button to begin speaking in either the input speaker's language or the other person's target language.

In some embodiments, the real-time translation system is configured to inform the non-English speaker user how to interact with the device. The user would tap the greeting button, and the device shows a message in the language of the non-English speaker, which can then be synthesized and heard by the person.

### Multi-Button Interface

In some embodiments, to identify the current speaker in a single device translation is to have a button in each portion of the interface. Each speaker pushes the button in the area corresponding to their language when they speak. Their speech can be determined to have ended either when they release the button or when the device detects that the speaker has been silent for one full second. Detecting the silence of the speaker may be done either by looking at the total volume or energy levels of the audio data or by using more advanced techniques such as neural networks trained to classify audio data. This classification can be done with a VAD, a speaker identification model, or a combination of the two.

### Single Button Interface

In some embodiments, identifying the current speaker in a single device translation involves using a single button to indicate that a speaker is about to begin a new utterance. When the button is pressed a neural network trained for language identification, dialect identification, speaker identification, or a combination of the above can then be used to determine which source language to use when generating translations to each target language.

### No Button Interface

In some embodiments, to identify the current speaker in a single device translation, the conversation can start without any button push after languages are selected or can use language identification to select languages at the start of a conversation allowing the conversation to start without any button push at all.

When operating without a button press required for participants to speak, the real-time translation application may have a button to allow participants to pause or resume listening for audio to translate. The application may start in either the paused or the active state.

### External/Hardware Button

On some devices, a special hardware button is present that can be associated with specific software applications on the device. These buttons can be configured to launch the translation application either in the paused or active mode.

### Translation Over Radio

It is also possible to integrate the translation solution into a radio system, so if the user hears a radio call that is in another language, the solution can automatically detect the other language and translate it into the user's language, and speak the translation out in the user's language. If the user wants to send a message back over the radio, they can speak in their local language, and the solution will automatically detect the language, automatically translate it into the target language, and then speak the translation out in the target language, broadcasting the speech audio over the radio communication, so the translated speech can be heard by other radios. Other radios do not need to have the translation solution in order to communicate.

A first example form for the radio translation is using a mobile device with the real-time translation app together with an accessory that plugs into the mobile device or connects via Bluetooth. The user selects the radio frequency to be used for audio input and for synthesized speech output. A second example form is a radio device that has an onboard computer that is capable of running the translation app and connecting the radio data to the audio inputs and outputs of the translation app. A third example form is possible with the mobile device placed near a dedicated radio with the mobile device's microphone listening to the radio and playing synthesized translated speech into the user's headphones, while also listening to the microphone attached to the user's headphones for input and then playing the synthesized translated speech from the mobile device's speaker.

### Common Translation Interface

Conversation History
   In various embodiments, the history of the conversation can be preserved in text form as well as input audio and input text for reference by all participants. This audio and text data can be augmented with time stamps, video, photographs, and/or GPS location data, for example. History can be viewed on the device and can be exported off of the device. History can also be sent to a server on the internet that can store and attest to the receipt of history information at a particular time and from a particular user, device, or network address.
Speech Detection
   Various techniques of detecting start and end of speech are possible during the translation process.
   One example approach is to use volume or energy measurements of a sample of audio data. This allows a binary classification of speaking or not speaking, with beginning and end of speech corresponding to transitions between these classifications.
   Another example approach is to use a classification model. Such a model can either classify sound sources (e.g., engine, dog barking, waves, music, speech), distinct speakers (e.g., “speaker 1”, “speaker 2”, “not a human speaker”), or may generate an embedding vector that can be used as an input to a classification model with either or both types of output.
   Additionally, such models may be trained to not only identify a single speaker or sound source but to identify a combination of sound sources or speakers present simultaneously in a single sample of audio data.
Use of Encryption
   In some embodiments, encryption can be used to protect privacy on-device and in transit. Cryptographic signatures can also be used to provide non-repudiation guarantees for chat histories.
   In some embodiments, each device can use appropriate mechanisms to manage a symmetric encryption key used for storing data locally. Such an encryption key should be stored whenever possible separately from the storage medium where the encrypted data resides. Technologies similar to Apple's Secure Enclave, Samsung Knox, or a TPM are recommended best practice for storing such encryption keys.
   In some embodiments, communication between devices and with network services can be encrypted using WiFi encryption techniques and/or TLS. Communication with TLS may be secured with certificate pinning in some high security use cases.
   In some embodiments, chat history can be signed on the device using a private key which is stored on the device. When hardware allows this private key should use an appropriate hardware mechanism to prevent exfiltration of the private key. The public key can be exported from the translation device and used to validate the authenticity of chat history.
   In some embodiments, non-repudiation can also be provided by a network connected service that receives chat history from the translation device either during or after a conversation. The network connected service can use its own private key to sign a hash of the chat history or fragment of chat history together with information about the device, user, and/or network address that requested the signature. This signed metadata then allows stronger verification of the authenticity and integrity of the chat history for legal non-repudiation purposes.
   In some embodiments, chat history can be archived to a network connected service (e.g., a remote server) to be stored for future use. This history could be stored either with or without signed metadata for non-repudiation purposes. Archived history may be unencrypted, encrypted at rest with a symmetric key available to the archival service, or encrypted using a public key algorithm such that decryption requires a private key not available to the archival service. Encryption of an archive such that the archival service is unable to decrypt the archive contents can be performed either on the translation device before upload or on the archival service before being written to a persistent storage medium.
Reverse Translations
   In some embodiments, in both single device and multi-device translation contexts, translation accuracy can be presented to the speaker by showing a round-trip or reverse translation of their statement. This is generated by translating their speech into a target language and then translating that output back into the original language. The speaker can then judge the accuracy of the translation by comparing the reverse translation to their original utterance.
Translation Error Mitigation
   Cascading speech translation systems (speech to text, text translation, text to speech) suffer from data loss between each step. In order to mitigate this, it is possible to use a token predicting language model to predict the next word, and compare that prediction with the output from the sequence to sequence model. This technique helps to detect and remediate errors in the speech recognition output, as well as the text translation output, by comparing the outputs to a probabilistic output from a language model that is fluent in that language, and either presenting the higher scored option to the user, or automatically using the higher scored option.
Language and Dialect Identification
   Language identification models exist to classify audio data by generating a probability distribution over known languages. This process can be improved or refined by using the first part of those models which creates a vector embedding and creating a new second part which translates this embedding into a probability distribution over dialects instead of a probability distribution over languages. In some cases, it can be helpful to make minor modifications to the embedding sub-model to have more values (dimensions) in the output vector. This can be done by modifying the final layers to use a higher dimensionality or by using the values from the last N layers together and concatenating them into a single vector.
   Common ways to perform the second step of classifying an embedding vector include logistic regression and probabilistic linear discriminant analysis (PLDA).
Identifying specific dialects can allow the translation to use a model specific to those dialects. This allows higher quality translations and avoids confusions that may occur otherwise with speakers of the same language that use different dialects.
Translation Context
   Many kinds of ambiguity can arise during translation. Some of this ambiguity is present in the originating language, such as when a sentence contains words with multiple definitions, pronouns without an antecedent, or is otherwise generally underspecified. In some embodiments, these ambiguities can be addressed by taking context into consideration in the form of previous utterances in the same conversation. Specifically, for example, the transcription of previous lines of the conversation can be prepended to the translation decoder's inputs as if they were generated by previous iterations of the decoder. Depending on the decoder model, there will be limitations on the length of the decoder's inputs. If the transcription exceeds the maximum allowable length, then the largest suffix of the transcription history that will fit is used after removing any leading utterance fragment from the suffix (i.e., the suffix consists only of complete utterances). Allowing the translation decoder to reference these previous parts of the conversation can improve translations by resolving ambiguity.
   Another kind of ambiguity that can arise during translation relates to information that is inherently part of the word choice or grammar in one language but is irrelevant in another language. Examples of this include languages where factors like age, seniority, or gender of the participants changes the correct translation. One way to detect such ambiguities is by knowing the attributes of each source and destination language. If the source language does not have a distinction based on those factors and the target language does, the speaker or recipient can be prompted to optionally specify which form the translation should take. This is an important bit of context for translation but applies to the entire interaction between the participants and does not change during the conversation. This conversation level context can be presented to the translation decoder either as special prefix tokens that indicate these attributes of the conversation, or as a vector embedding that carries the same information.
Automatic Speaker ID
   In some embodiments, speaker identification is performed by using a model that converts an audio segment into a vector embedding that represents the identity of the primary speaker in the segment. This vector embedding is then compared to the vector embeddings of other speakers previously seen in this conversation. The comparison between vector embeddings is done using a classification algorithm such as PLDA. When a new speaker is detected, a vector representing that speaker is added to the list of known speakers in the current conversation for future comparisons. If the vector embedding matches a pre-existing speaker, then the utterance is attributed to that speaker.
   In some embodiments, when speaker identification models are used, it is possible to attribute each sample of audio data to a specific speaker or combination of speakers. This allows for generating a chat history that identifies the speaker of each piece of text. This also allows using the desired speaker's identification as an input to an ASR algorithm to more accurately extract that speaker's voice from audio which may include multiple simultaneous speakers. Identification of each speaker's text allows for more accurate identification of the conversational context of a speaker's statements, which can allow more accurate translation of statements requiring context to be understood. For example, providing previous statements from a speaker as part of the context window for a decoder model to generate a translation sequence allows the model to consider the relationship of those previous statements to the current text to be translated.
Ambiguity Identification and Resolution
   In some embodiments, ambiguity can be detected by inspecting the probability distribution of the next token from the translation decoder. This is closely related to the perplexity of the distribution over translations. One definition of ambiguity can be the number of possible next tokens within a sampling nucleus. For an appropriately sized sampling nucleus most inferences will only have a single option available. When more than one option is available within the nucleus, this suggests ambiguity. The smaller the difference in probability between the first two options the greater the ambiguity. This can be shown to also imply a higher perplexity of the distribution over possible translations.
   Ambiguities of this sort suggest that there is a possibility for a mistake in the translation, and these ambiguities can often be resolved by providing additional context as described under the “Translation Context” heading above. When such an ambiguity in a translation is detected, the speaker or recipient can be prompted with a choice to resolve the ambiguity. In the case of an ambiguity present in the original language, the output can be linked to the input by either considering the attention weights of the pass generating the ambiguous token or by completing the translation of the word each way and then presenting the reverse translations of each possibility to the speaker. If there are multiple ambiguities in a single utterance then the possible translations may branch at each ambiguity, performing a beam search and allowing the speaker to choose the translation with their preferred reverse translation.
   The best translation from a beam search can also be selected automatically by using a metric such as a BLEU score, a ROUGE score, or any other translation quality metric to find the reverse translation that has the closest match to the original input.

### Nativo™ Translation Feedback and Refinement System & Method

Nativo™ is a new system provided by myLanguage™ system to allow native and professional speakers of foreign languages to grade and verbally or manually type in correct translations to their language from English. The system takes phrases from myLanguage Translator implementation, and we also allow operators to upload phrases in English. These phrases are then automatically translated using the myLanguage™ Translator platform. Nativo users then log into the system, select their language, and review the translations created by the myLangauge™ Translator platform.

In some embodiments, the verbal recordings of the correct translations are converted to text. The verbal recordings are then used to optimize and train the Automatic Speech Recognition (ASR) and Text to Speech (TTS) models of the myLanguage Translator models. The text translations are used to train the Neural Machine Translation (NMT) models.

The foreign speaker can also add comments to indicate language-specific nuances (like gender, or formal vs casual).

Translations will then continually improve from feedback from the user population and from translation experts.
Submissions from Translator
   In some embodiments, users of the myLanguage™ Translator Application can flag any sentence that they believe can be improved. This will upload the recording of the speaker's voice if present along with the text version in their original language, the target language, and the translation into the target language.
Input from Reviewers
   1. Prioritizing Data for Review
      a. In some embodiments, Nativo will identify submissions that have a low number of reviews and/or a high statistical uncertainty in the reviews. This can form a basis for prioritizing the submissions that can most benefit from additional information from reviewers.
   2. Classifying Sentence Context
      a. Reviewers can label sentences based on any implied conversational context. For example, if a sentence is appropriate when speaking to someone of a certain age or gender that information can be added to the sentence. This information then can help to further refine the language models.
   3. Reviewer Incentives
      a. Reviewers can be granted incentives for translation in the form of points on the website. Good translations can be rewarded with congratulatory text or graphics displayed to the user. These points can be shown to others or viewed on a site-wide leaderboard. Cash rewards and product discounts may also be provided for users based on the volume and/or priority of their contributions. Reviewers who provide a lot of high-quality suggestions can be promoted to become a moderator and their contributions carry more weight than reviewers with less contributions.
   4. Collation of Reviewer Data
      a. Reviewer data for the same submission can be compared and examined statistically. Once enough feedback from reviewers has been gathered to make a high confidence decision in the correct translation and/or sentence context, that information can be used to further refine language models. Additionally, if all desired information has been obtained with high confidence, then this submission can be deprioritized and either not shown or only infrequently shown to future reviewers.
      b. Reviewers might provide erroneous submissions. In order to mitigate the chance of trusting bad submissions, we will use a variety of operations to combine values when deciding whether to trust submissions. These values can include ASR confidence (how well does their speech and text match other speech and text in the ASR model), Dialect model confidence (how well does their speech match the specific dialect they are providing a submission for), Reverse Translation BLEU score or any other translation quality metric (how well does the reverse translation of their submission match the original input), Contributor historical confidence (how many good submissions has this Reviewer provided in the past), Moderator confidence score (how does the moderator rate this submission).

Although the foregoing embodiments have been described in some detail for purposes of clarity of understanding, the invention is not limited to the details provided. There are many alternative ways of implementing the invention. The disclosed embodiments are illustrative and not restrictive.

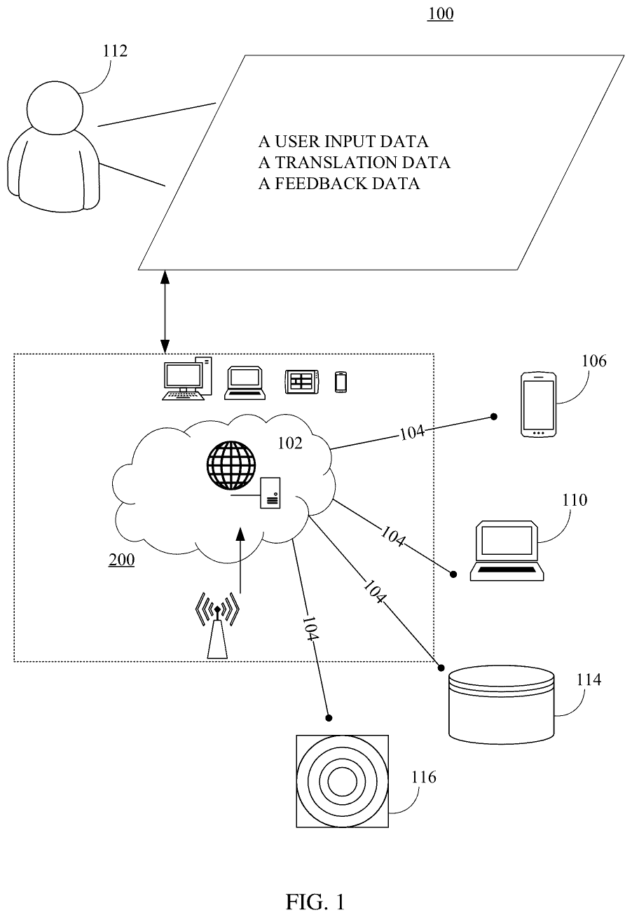

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

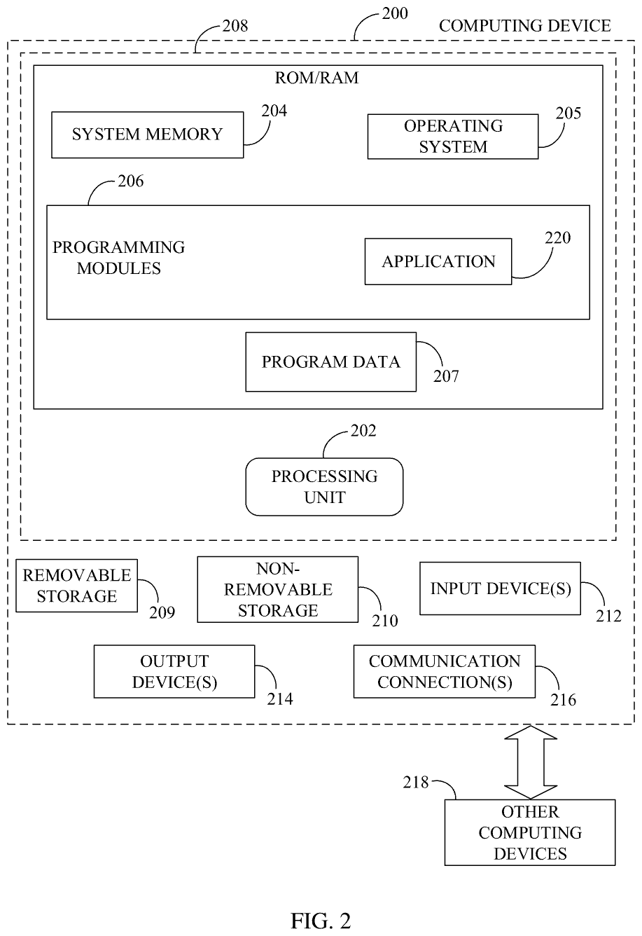

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

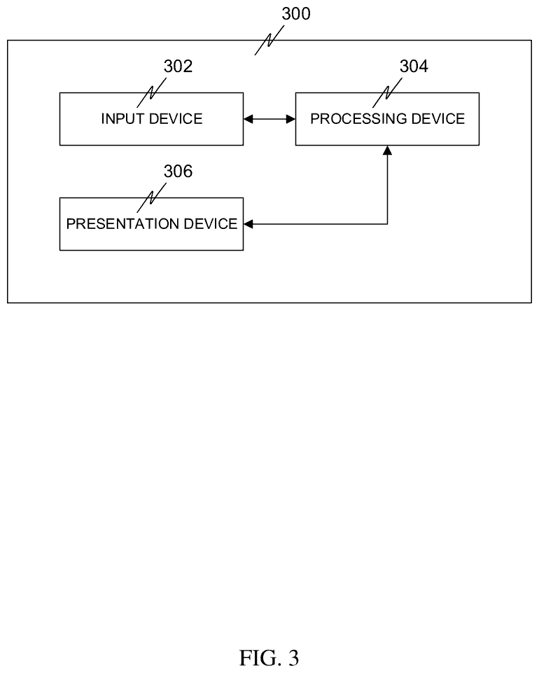

FIG. 3 illustrates a block diagram of a real-time language translation system 300 embodied in a physical device, in accordance with some embodiments.

Accordingly, the real-time language translation system 300 may include an input device 302 which may be configured for receiving generating user input data representing a linguistic input from a user. Further, the linguistic input corresponds to a user language. Further, the real-time language translation system 300 may include a processing device 304 which may be configured for generating translation data based on the user input data. Further, the translation data represents a translation of the linguistic input. Further, the generating may be based on an AI module. Further, the processing device 304 may be communicatively coupled to the input device 302. Further, the real-time language translation system 300 may include a presentation device 306 which may be configured for presenting the translation data. Further, the presentation device 306 may be communicatively coupled to the processing device 304.

In some embodiments, the physical device may be configured to be affixed on a user device associated with the user. Further, the physical device may be configured to be communicatively coupled to the user device. Further, the physical device includes one or more of a mobile case and an enclosed backpack.

In some embodiments, the user input data includes one or more of an audio data corresponding to an audio input from the user and a textual data corresponding to a text input from the user.

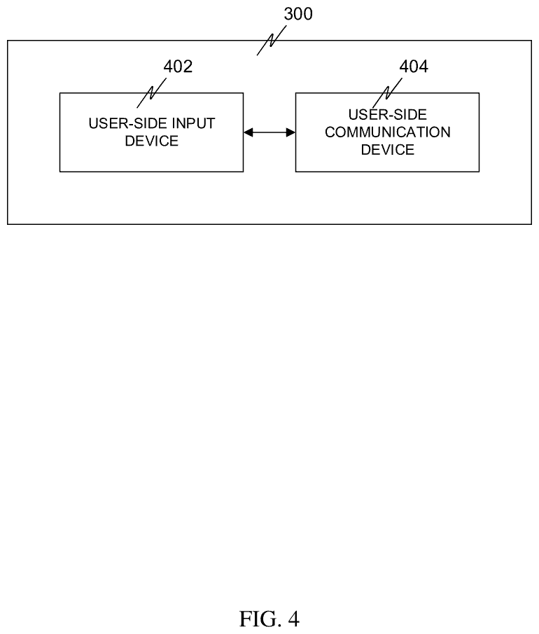

FIG. 4 illustrates a block diagram of the real-time language translation system 300 embodied in a physical device, in accordance with some embodiments.

Further, in some embodiments, the real-time language translation system 300 further may include a user-side input device 402 associated with the user device which may be configured for generating the user input data from the user. Further, in some embodiments, the real-time language translation system 300 further may include a user-side communication device 404 which may be configured for transmitting the user input data to the processing device 304. Further, the user-side communication device 404 may be communicatively coupled to the processing device 304.

In some embodiments, the translation data includes a GUI data which may be configured for presenting a GUI on the presentation device 306. Further, the GUI data includes an activation data representing an activation parameter which may be configured to initiate generating the user input data by the input device 302 associated with the user.

In some embodiments, the user device includes two or more user devices associated with two or more users. Further, each of the two or more user devices includes a first user device and a second user device. Further, the first user device and the second user device may be interconnected using a wireless communication network. Further, each of the first communication device and the second communication device includes a connectivity module which may be configured for connecting to the wireless communication network. Further, the connecting may be based on a security protocol.

In some embodiments, the user input data includes two or more user input data corresponding to each of the two or more users. Further, the two or more user devices include a first user device associated with a first user and a second user device associated with a second user. Further, the input device 302 includes a first-user input device associated with the first user device. Further, the processing device 304 includes a first-user processing device associated with the first user device. Further, the translation data may be presented on the second user presentation device associated with the second user device.

In some embodiments, the input device 302 includes a second user input device associated with the second user device. Further, the processing device 304 includes a second user processing device associated with the second user device. Further, the translation data may be presented on the first user presentation device associated with the first user device.

In some embodiments, the audio data includes an audio representation data corresponding to a representation of the audio data. Further, the audio representation data includes one or more of raw audio data, a fourier transformation data, a spectrogram data, a mel-frequency cepstal coefficient data and a vector embedding data. Further, the raw audio data corresponds to an unprocessed audio input. Further, the fourier transformation data of the audio data corresponds to converting an audio waveform associated with the audio data from a time domain to a frequency domain. Further, the spectrogram data corresponds to a visual representation of a spectrum of frequencies associated with the audio data. Further, the mel-frequency cepstal coefficient data represents a short-term power spectrum of the audio input. Further, the vector embedding data corresponds to a vector representation of the audio data.

In some embodiments, the AI module includes two or more AI modules.

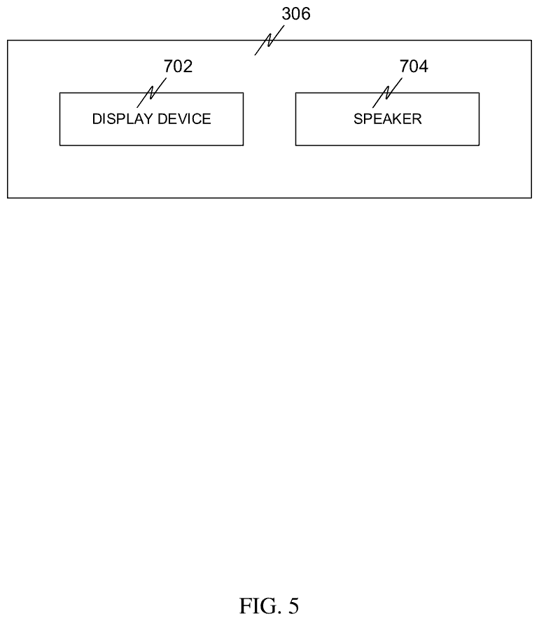

FIG. 5 illustrates a block diagram of a presentation device 306 included in the real-time language translation system 300 embodied in a physical device, in accordance with some embodiments.

In some embodiments, the user input data includes audio data corresponding to an audio input from the user. Further, the audio data may be in user language. Further, the audio data includes audio characteristic data corresponding to a characteristic associated with the audio input. Further, the audio data further includes one or more of a speech data and a noise data. Further, the speech data represents a word spoken by the user. Further, the noise data represents the audio data excluding the speech data. Further, the two or more AI modules include a voice activity detection AI module which may be configured for detecting the speech data from the audio data. Further, the detection may be based on the audio characteristic data associated with the audio input. Further, the two or more AI modules further includes an automatic speech recognition AI module which may be configured for generating text data based on the speech data. Further, the generating may be based on Connectionist Temporal Classification Beam Search algorithm. Further, the automatic speech recognition AI module may be further configured for tokenizing the text data to a tokenized text data associated with the text data. Further, the two or more user devices include a first user device associated with a first user and a second user device associated with a second user. Further, the two or more AI modules includes a neural machine translation AI module further which may be configured for translating the tokenized text data representing the first user language associated with the first user into a translated tokenized text data representing the second user language associated with the second user. Further, the neural machine translation AI module may be further configured for translating translated tokenized text data representing the second user language to the tokenized text data representing the first user language. Further, the two or more AI modules further includes a text to speech AI module which may be configured for generating a translated audio data corresponding to a translated user language from the audio data. Further, the presentation device 306 includes a display device 702 which may be configured to display each of the text data corresponding to the tokenized text data and the translated text data corresponding to the translated text data. Further, the presentation device 306 includes a speaker 704 which may be configured to present the translated audio data.

In some embodiments, the user input data includes two or more user input data corresponding to two or more users. Further, the user language includes two or more user languages corresponding to the two or more user input data. Further, each of the two or more user languages includes two or more user dialects. Further, the two or more AI modules further includes one or more of a user ID AI model, a language ID AI model and a dialect ID AI model. Further, the user ID AI model may be configured for generating a user ID data corresponding to each of the two or more users based on the user input data. Further, the language ID AI model may be configured for generating a user language ID data corresponding to each of the two or more user languages based on the user input data. Further, the dialect ID AI model may be configured for generating a user dialect ID data corresponding to each of the two or more user dialects based on the user input data.

In some embodiments, the translation data includes a GUI data which may be configured for presenting a GUI on the presentation device 306. Further, the GUI data includes a language detection button data corresponding to initiation of generating the user language ID data based on the language ID AI model.

In some embodiments, the user input data includes audio data corresponding to an audio input from the user. Further, the audio data includes audio characteristic data corresponding to a characteristic associated with the audio input. Further, the audio characteristic data includes an audio energy level data corresponding to an energy level associated with the audio input. Further, the energy level further corresponds to a numerical value associated with the audio data.

In some embodiments, the real-time language translation system 300 may further include a storage device 802 which may be configured for storing each of the user input data and the translation data associated with the user input data.

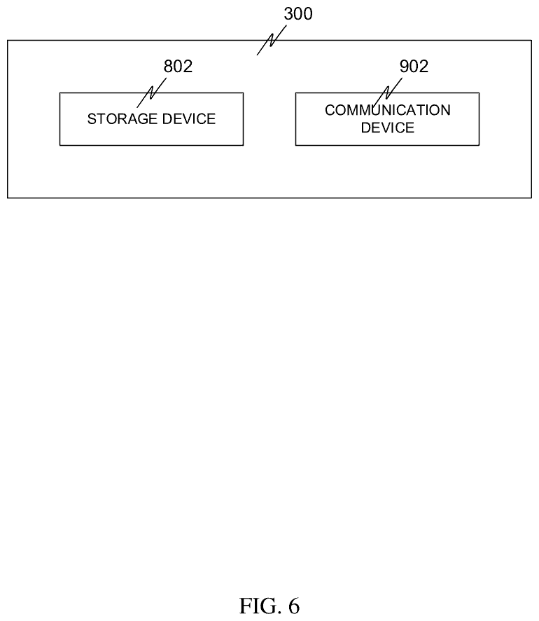

FIG. 6 illustrates a block diagram of the real-time language translation system 300 embodied in a physical device, in accordance with some embodiments.

Further, in some embodiments, the real-time language translation system 300 further may include the storage device 802 further which may be configured for retrieving the user input data and the associated translation data. Further, in some embodiments, the real-time language translation system 300 further may include a communication device 902 which may be configured for transmitting each of the user input data and the translation data associated with the user input data to an external server.

In some embodiments, the translation data may be presented on a user display device associated with the user device. Further, the user device includes a user input device which may be configured for receiving feedback data corresponding to a feedback of the translation data. Further, the user device further includes a user-processing device which may be configured for generating a modified translation data based on the feedback data. Further, the user display device may be further configured to present the modified translation data. Further, the generating may be based on the AI model. Further, the communication device 902 may be further configured for receiving each of the feedback data and the modified translation data.

In some embodiments, the user includes two or more users. Further, the GUI data includes a user screen data corresponding to a screen presented on a user display device associated with the user device. Further, the user screen data includes a multi button data corresponding to two or more buttons. Further, each of the two or more buttons may be associated with each of the two or more users. Further, the user display device may be further associated with the user device comprising a user input device which may be configured for receiving feedback data corresponding to a feedback corresponding to the multi button data. Further, the user device further includes a user-processing device which may be configured for generating a modified multi button data based on the feedback data. Further, the user display device may be further configured to present the modified translation data.

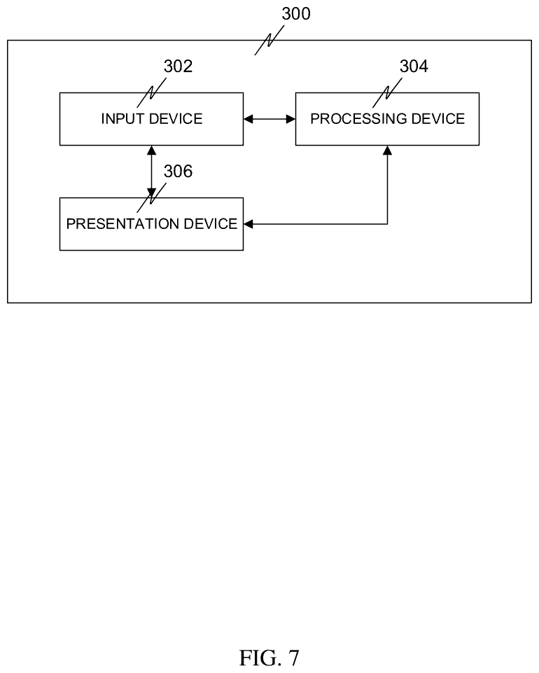

FIG. 7 illustrates a block diagram of the real-time language translation system 300 embodied in a physical device, in accordance with some embodiments.

Accordingly, the real-time language translation system 300 may include an input device 302 which may be configured for receiving generating user input data representing a linguistic input from a user. Further, the linguistic input corresponds to a user language. Further, the real-time language translation system 300 may include a processing device 304 which may be configured for generating translation data based on the user input data. Further, the translation data represents a translation of the linguistic input. Further, the generating may be based on an AI module. Further, the processing device 304 may be communicatively coupled to the input device 302. Further, the real-time language translation system 300 may include a presentation device 306 which may be configured for presenting the translation data. Further, the presentation device 306 may be communicatively coupled to the processing device 304. Further, the physical device may be configured to be affixed on a user device associated with the user. Further, the physical device may be configured to be communicatively coupled to the user device. Further, the physical device includes one or more of a mobile case and an enclosed backpack.

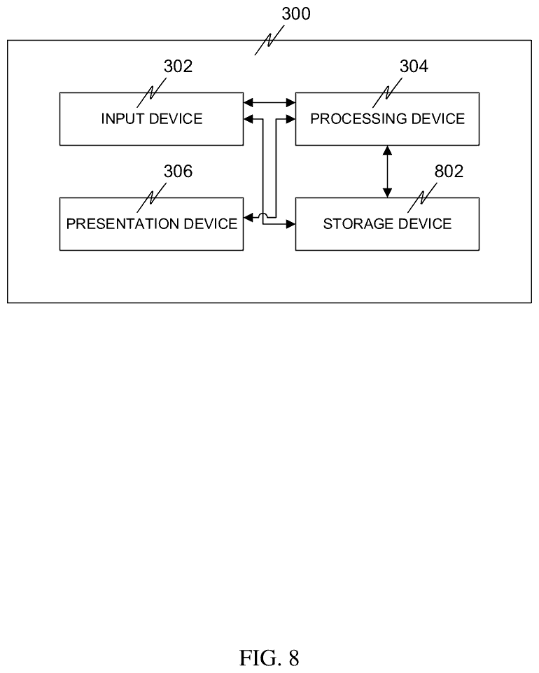

FIG. 8 illustrates a block diagram of the real-time language translation system 300 embodied in a physical device, in accordance with some embodiments.

Accordingly, the real-time language translation system 300 may include an input device 302 which may be configured for receiving generating user input data representing a linguistic input from a user. Further, the linguistic input corresponds to a user language. Further, the real-time language translation system 300 may include a processing device 304 which may be configured for generating translation data based on the user input data. Further, the translation data represents a translation of the linguistic input. Further, the generating may be based on an AI module. Further, the processing device 304 may be communicatively coupled to the input device 302. Further, the real-time language translation system 300 may include a presentation device 306 which may be configured for presenting the translation data. Further, the presentation device 306 may be communicatively coupled to the processing device 304. Further, the real-time language translation system 300 may include a storage device 802 which may be configured for storing each of the user input data and the translation data associated with the user input data.

In some embodiments, the input device 302 includes a microphone which may be configured for sensing sound corresponding to the audio data.

In some embodiments, the presentation device 306 includes a speaker 704.

In some embodiments, the presentation device 306 includes a user display device associated with the user device.

In some embodiments, the user device includes a handheld device.

In some embodiments, the handheld device includes a mobile phone.

In some embodiments, the physical device includes a floatation component which may be configured for providing a floatation capability in a maritime environment. Further, the floatation capability corresponds to a capability to float in water. Further, the floatation capability may be based on Archimedes principle.

In some embodiments, the floatation component includes a buoyant component which may be configured for providing buoyancy.

In some embodiments, the floatation component further includes an air-filled component which may be configured for providing the floatation capability.

In some embodiments, the input device 302 includes a hardware button. Further, the receiving of the user input from the user may be based on an actuation of the hardware button.

In some embodiments, the wireless communication network includes one or more of a Wifi network, a local area network and a radio communication network.

In some embodiments, the security protocol includes a TLS protocol.

In some embodiments, the wireless communication network includes a security mechanism which may be configured to require an authentication from each of the first user device and the second user device for connecting to the wireless communication network.

In some embodiments, the authentication includes each of an SSID corresponding to an ID associated with the wireless communication network and an encryption key corresponding to the SSID.

In some embodiments, the input device 302 includes a user-side input device 402 associated with the user device. Further, the processing device 304 includes a user-side processing device associated with the user device.

In some embodiments, the user device includes a wearable device.

In some embodiments, the user device includes a VHF radio.

In some embodiments, the user device includes one or more of a desktop computer and a laptop.

In some embodiments, the user language includes two or more user languages corresponding to the two or more user input data.

In some embodiments, the audio representation data includes a partial audio data corresponding to a portion of the audio data.

In some embodiments, the audio representation data includes a text transcription data representing the audio data converted to a textual transcription.

In some embodiments, the audio characteristic data includes an audio signal data corresponding to a signal level of the audio input.

In some embodiments, the audio signal data includes one or more of an audio frequency data corresponding to a frequency of the audio input and an audio amplitude data corresponding to the amplitude of the audio input.

In some embodiments, the user input data includes audio data corresponding to an audio input from the user. Further, the audio data further includes one or more of a speech data and a noise data. Further,

The speech data represents a word spoken by the user. Further, the noise data represents the audio data excluding the speech data. Further, the two or more AI modules include a voice activity detection AI module which may be configured for detecting the speech data from the audio data. Further, the detection may be based on the audio characteristic data associated with the audio input.

In some embodiments, the audio data includes two or more audio data. Further, each of the two or more audio data may be associated with a time instance. Further, the detecting further includes analyzing each of the two or more audio data in relation to the time instance.

In some embodiments, the user input data includes audio data corresponding to an audio input from the user. Further, the audio data further includes one or more of a speech data and a noise data. Further, the speech data represents a word spoken by the user and the noise data represents the audio data excluding the speech data.

In some embodiments, the two or more AI modules include an automatic speech recognition AI module which may be configured for generating a text data based on the speech data. Further, the generating may be based on Connectionist Temporal Classification Beam Search algorithm.

In some embodiments, the automatic speech recognition AI module may be further configured for tokenizing the text data to a tokenized text data associated with the text data.

In some embodiments, the user language includes two or more user languages corresponding to the two or more user input data.

In some embodiments, the two or more user devices include a first user device associated with a first user and a second user device associated with a second user. Further, the two or more AI modules includes a neural machine translation AI module which may be configured for translating the tokenized text data representing the first user language into a translated tokenized text data representing the second user language.

In some embodiments, the neural machine translation AI module may be further configured for translating translated tokenized text data representing the second user language to the tokenized text data representing the first user language.

In some embodiments, the audio data includes audio fragment data.

In some embodiments, the audio fragment data includes two or more audio fragment data corresponding to two or more audio inputs. Further, each of the two or more audio fragment data corresponds to a user dialect.

In some embodiments, the feedback data includes a comment data corresponding to a comment by the user based on a language characteristic associated with the user language.

In some embodiments, the language characteristic includes one or more of a gender characteristic, an age characteristic and a language style characteristic.

In some embodiments, the language style characteristic includes one or more of a formal characteristic and a casual characteristic.

In some embodiments, the processing device 304 may be further configured for training the AI module based on the feedback data.

In some embodiments, the user device includes an earbud corresponding to a device comprising each of a headphone and a microphone.

In some embodiments, the earbud includes an airpod.

In some embodiments, the translation data includes a GUI data which may be configured for presenting a GUI on the presentation device 306. Further, the GUI data includes a user screen data corresponding to a screen presented to the user.

In some embodiments, the user includes two or more users. Further, the two or more users includes one or more of a first user and a second user.

In some embodiments, the GUI data includes two or more GUI data associated with two or more user screen data. Further, the two or more GUI data includes each of a first GUI data representing a first user screen data associated with the first user and a second GUI data representing a second user screen data associated with the second user.

In some embodiments, the translation data includes a GUI data which may be configured for presenting a GUI on the presentation device 306. Further, the GUI data includes a user screen data corresponding to a screen presented on the user display device associated with the user device. Further, the user screen data includes a target language button data corresponding to a button which may be configured for generating the translation data representing the target language based on the user language.

In some embodiments, the translation data includes a GUI data which may be configured for presenting a GUI on the presentation device 306. Further, the GUI data includes a user screen data corresponding to a screen presented on the user display device associated with the user device. Further, the user screen data includes a greeting button data corresponding to a button which may be configured to present a list of languages for the user.

In some embodiments, the user device further includes a user-communication device which may be configured for transmitting the modified multi button data to the communication device 902.

In some embodiments, each of the storing and retrieving may be performed based on an encryption protocol.

In some embodiments, the encryption protocol includes a TLS protocol.

In some embodiments, the user includes two or more users. Further, the two or more users includes one or more of a first user and a second user. Further, the user input data includes a user characteristic data corresponding to a characteristic of the user associated with the user input data. Further, the two or more AI modules include a classification AI module which may be configured to detect the user from the user input data. Further, the detecting may be based on the user characteristic data.

In some embodiments, the user characteristic data includes a pitch data corresponding to a pitch of a user voice associated with the user.

In some embodiments, the user characteristic data includes a volume data corresponding to a volume of a user voice associated with the user.

In some embodiments, the processing device 304 may be further configured to generate user incentive data corresponding to a reward allocated to the user based on the feedback.

In some embodiments, the reward includes one or more of a point, a credit and a discount coupon allocated to the user.

In some embodiments, the processing device 304 may be further configured for analyzing each of the feedback and the reward associated with the user.

### Offline System Overview

In various embodiments, the real-time language translation system may be configured for complete offline operation, enabling users to translate spoken words from one language and/or dialect to another without requiring any Internet or external network connectivity. Specifically, all core modules [i.e., language identification (LID), automatic speech recognition (ASR), neural machine translation (NMT), and text-to-speech (TTS)] can reside and execute on-device. These modules are stored in local memory (e.g., non-volatile flash storage, microSD card, solid-state drive, or other embedded media) to ensure real-time responsiveness and robustness in scenarios where connectivity is limited or unavailable.

When in offline mode, the following processes occur on the device:
Language Identification (LID): The device runs a locally stored model that is trained on multiple languages and dialects, enabling it to detect or classify the most likely language and dialect from the audio input without any server communication.
Speech Recognition (ASR): Once the LID model has identified the language and dialect, the ASR module-loaded in memory-converts spoken input into text in that specified language/dialect. The ASR model may utilize prefix tokens or prompts to indicate the particular language/dialect context provided by the LID model.
Neural Machine Translation (NMT): ** The recognized text is then locally processed by an NMT model, which translates the text from the source language/dialect to the target language/dialect. The NMT model may also leverage prefix tokens to specify source and target language/dialect, enabling more accurate and context-sensitive translations.
Text-to-Speech (TTS): ** Finally, the device synthesizes audio output in the target dialect using a locally stored TTS model. This TTS model can generate voice output that approximates the dialect in question for more natural conversation.

All such operations (i.e., including but not limited to model inference, tokenization, translation, speech synthesis, and user interaction) are fully contained within the physical device hardware and require no external network resources. By storing inference models locally, the system ensures complete autonomy and privacy for offline scenarios.

### Optional Connectivity for Updates and Feedback

In addition to fully autonomous offline operation, some embodiments permit optional connectivity (e.g., Wi-Fi, cellular, radio, or other networks) to upload usage metrics, feedback data, or partial transcripts for further review. This connectivity can also be used to download updated or more advanced versions of the LID, ASR, NMT, and TTS models, as well as new language packs or dialect expansions. The system may include an update interface that performs a secure handshake with a remote server to download newly trained or refined models. When network access is available, the device can:
Push Usage Data and Feedback: The device can upload anonymized usage logs, user feedback (e.g., acceptance/rejection of certain translations, user corrections), and acoustic samples that help refine and retrain the models. Data is secured by encryption protocols (such as TLS) before transmission.
Model/Patch Downloads: The device can receive updated or additional language/dialect models whenever the user opts to enhance system capability. The user may select which language or dialect modules to install or refresh, ensuring the device remains lean and only carries data relevant to the user's actual needs.
Retraining & Deployment Cycle: A remote server may aggregate usage data from multiple devices, retrain or fine-tune the AI modules, then make the revised models available for download by devices that have connectivity.

At all times, the default mode remains offline-capable. If connectivity is lost or disabled, the device continues to function using the locally stored models without interruption.

### Lid and Dialect Handling

In terms of language identification (LID), the LID component uses a multi-lingual and multi-dialect acoustic analysis approach that has been trained on large-scale corpora of spoken data. In one embodiment, the model structure includes an embedding network that processes audio segments and outputs latent features, followed by classification layers capable of distinguishing among a wide variety of languages and sub-languages/dialects. During training, each audio sample is tagged with a language/dialect label, and these labels guide the model in learning distinctive features for each dialect.

When the system receives audio offline, the LID module is invoked first to identify the most likely language and dialect. This is done through short segments of audio, which the model classifies into one of the known language-dialect categories within its training. The final output is then passed as a prefix token or parameter to subsequent modules (e.g., ASR, NMT).

In terms of ASR with Language/Dialect Prefix, the ASR module receives a prefix token (or other encoded parameter) that specifies the language and dialect chosen by the LID module. The ASR network is trained to handle multiple languages and dialects by referencing these tokens, which condition the neural layers to parse phonemes, graphemes, or subword units in the specified dialect. This multi-language, multi-dialect approach ensures that the same core ASR model can handle numerous forms of speech. The on-device inference framework loads the relevant weights and performs recognition completely offline.

In terms of NMT with Source and Target Language/Dialect Prefixes, after the source text has been recognized, an NMT model processes it to generate a translation in the target language and dialect. The system again employs prefix tokens to indicate both the source and target language/dialect. This allows the model to account for dialectal variations in vocabulary, syntax, and idioms. In an offline mode, the user can select or store multiple NMT models, or a single universal model capable of multi-lingual translation. The NMT model uses standard sequence-to-sequence architectures with attention or transformer-based components to yield translations in real time.

In terms of TTS Synthesis for destination dialect, and in terms of audio output, a TTS engine is employed that similarly incorporates dialect/language information. Once the NMT output is generated, the device instructs the TTS engine to synthesize the target message in the user's desired dialect. Offline TTS models for each language/dialect can be stored on the device (subject to storage constraints). Optionally, smaller or quantized TTS models may be loaded dynamically, or only those relevant to the user's selected dialect(s).

### Training and Model Optimization

To enable practical on-device operation, each of the AI modules (i.e., LID, ASR, NMT, TTS) is trained or fine-tuned using a combination of model compression and optimization techniques. Some non-limiting examples include:
Teacher-Student Model Distillation: A larger, more accurate “teacher” model is used to guide the training of a more compact “student” model. The smaller “student” preserves performance while having fewer parameters, making it suitable for offline, resource-constrained devices.
Domain-Specific Fine-Tuning: Subsets of the model weights may be fine-tuned on domain-specific corpora relevant to typical usage scenarios (e.g., maritime, medical, tourism). This ensures the offline system still yields high accuracy in relevant domains.
Low-Rank Adaptation (“LoRA”): Additional low-rank matrices are inserted into certain layers, allowing rapid adaptation to new languages, dialects, or specialized vocabularies without retraining the entire model.
Quantization and Pruning: Model weights may be quantized to lower precision (e.g., 8-bit or 4-bit) and selectively pruned to remove redundant parameters. Such techniques can shrink model size and reduce memory usage without severely impacting performance, thus improving inference speed and making the system more feasible for offline hardware.
QLoRA: In some implementations, QLoRA further combines quantization with LoRA-based adaptation. This dual approach can drastically reduce memory footprint while preserving the model's ability to adapt to new domains or dialects.
Other Optimization: Additional strategies such as knowledge distillation for NMT, structured pruning for TTS, and specialized activation functions for ASR can be utilized to achieve real-time inference on embedded or mobile-grade hardware.

Collectively, these techniques allow large-scale, multi-dialect speech models to be compressed or modularized in ways that maintain practical performance offline, even on relatively low-power devices.

### Offline and Connected Modes

Offline Mode (Default):
   The device performs end-to-end translation locally.
   All data remains on the device, protecting user privacy and ensuring operation in remote locations.
   No external servers or network connections are needed for normal usage.
Optional Connected Mode:
   If connectivity is available, the user may opt to send usage data, correction feedback, or partial transcripts to a secure server for analytics or retraining of the AI models.
   The server may provide periodic model updates, new language packs, and improvements for LID, ASR, NMT, and TTS modules, which the user can choose to download and install.
   Data is protected in transit (e.g., TLS or other encryption) to preserve security and confidentiality.

Thus, the system supports both a self-sufficient offline workflow and an enhanced cloud-assisted model refinement cycle. Even with cloud interaction, the system is designed to remain fully functional if network service is lost or unavailable.

In some exemplary embodiments, the real-time language translation system may further comprise a storage module, an offline inference engine, and optional communication interface, a compression and adaptation framework, and a dialect labeling mechanism. The storage module can be used to store a local LID model, a local ASR model, a local NMT model, and a local TTS model. The offline inference engine can be configured to execute the local LID, ASR, NMT, and TTS models without requiring an external network connection. The optional communication interface may be configured to upload usage data or download updated models when network connectivity is available. The compression and adaptation framework can utilize at least one of teacher-student distillation, low-rank adaptation, quantization, pruning, and domain-specific fine-tuning to reduce model size while preserving translation accuracy. The dialect labeling mechanism, in which each audio sample is tagged during training, can enable the LID model to identify specific dialects, the ASR model to parse speech accordingly, the NMT model to incorporate source and target dialect prefix tokens, and the TTS model to synthesize output in a dialect appropriate to the user.

Although the invention has been explained in relation to its preferred embodiment, it is to be understood that many other possible modifications and variations can be made without departing from the spirit and scope of the invention as hereinafter claimed.

What is claimed is:

1. A real-time language translation system embodied in a physical device, wherein the real-time language translation system comprises:
an input device configured for receiving generating a user input data representing a linguistic input from a user, wherein the linguistic input corresponds to a user language;
a processing device configured for generating a translation data based on the user input data, wherein the translation data represents a translation of the linguistic input, wherein the generating is based on an AI module, wherein the processing device is communicatively coupled to the input device; and
a presentation device configured for presenting the translation data, wherein the presentation device is communicatively coupled to the processing device.

2. The real-time language translation system of claim 1, wherein the physical device is configured to be affixed on a user device associated with the user, wherein the physical device is configured to be communicatively coupled to the user device, wherein the physical device comprises at least one of a mobile case and an enclosed backpack.

3. The real-time language translation system of claim 1, wherein the user input data comprises at least one of an audio data corresponding to an audio input from the user and a textual data corresponding to a text input from the user.

4. The real-time language translation system of claim 2 further comprises:
a user-side input device associated with the user device configured for generating the user input data from the user; and
a user-side communication device configured for transmitting the user input data to the processing device, wherein the user-side communication device is communicatively coupled to the processing device.

5. The real-time language translation system of claim 1, wherein the translation data comprises a GUI data configured for presenting a GUI on the presentation device, wherein the GUI data comprises an activation data representing an activation parameter configured to initiate generating the user input data by the input device associated with the user.

6. The real-time language translation system of claim 2, wherein the user device comprises a plurality of user devices associated with a plurality of users, wherein each of the plurality of user devices comprises a first user device and a second user device, wherein the first user device and the second user device are interconnected using a wireless communication network, wherein each of the first communication device and the second communication device comprises a connectivity module configured for connecting to the wireless communication network, wherein the connecting is based on a security protocol.

7. The real-time language translation system of claim 6, wherein the user input data comprises a plurality of user input data corresponding to each of the plurality of users, wherein the plurality of user devices comprises a first user device associated with a first user and a second user device associated with a second user, wherein the input device comprises a first-user input device associated with the first user device, wherein the processing device comprises a first-user processing device associated with the first user device, wherein the translation data is presented on the second user presentation device associated with the second user device.

8. The real-time language translation system of claim 6, wherein the input device comprises a second user input device associated with the second user device, wherein the processing device comprises a second user processing device associated with the second user device, wherein the translation data is presented on the first user presentation device associated with the first user device.

9. The real-time language translation system of claim 3, wherein the audio data comprises an audio representation data corresponding to a representation of the audio data, wherein the audio representation data comprises at least one of a raw audio data, a fourier transformation data, a spectrogram data, a mel-frequency cepstal coefficient data and a vector embedding data, wherein the raw audio data corresponds to an unprocessed audio input, wherein the fourier transformation data of the audio data corresponds to converting an audio waveform associated with the audio data from a time domain to a frequency domain, wherein the spectrogram data corresponds to a visual representation of a spectrum of frequencies associated with the audio data, wherein the mel-frequency cepstal coefficient data represents a short-term power spectrum of the audio input, wherein the vector embedding data corresponds to a vector representation of the audio data.

10. The real-time language translation system of claim 1, wherein the AI module comprises a plurality of AI modules.

11. The real-time language translation system of claim 1, wherein the user input data comprises an audio data corresponding to an audio input from the user, wherein the audio data is in user language, wherein the audio data comprises an audio characteristic data corresponding to a characteristic associated with the audio input, wherein the audio data further comprises at least one of a speech data and a noise data, wherein the speech data represents a word spoken by the user, wherein the noise data represents the audio data excluding the speech data, wherein the plurality of AI modules comprises a voice activity detection AI module configured for detecting the speech data from the audio data, wherein the detection is based on the audio characteristic data associated with the audio input, wherein the plurality of AI modules further comprises an automatic speech recognition AI module configured for generating a text data based on the speech data, wherein the generating is based on Connectionist Temporal Classification Beam Search algorithm, wherein the automatic speech recognition AI module is further configured for tokenizing the text data to a tokenized text data associated with the text data, wherein the plurality of user devices comprises a first user device associated with a first user and a second user device associated with a second user, wherein the plurality of AI modules comprises a neural machine translation AI module further configured for translating the tokenized text data representing the first user language associated with the first user into a translated tokenized text data representing the second user language associated with the second user, wherein the neural machine translation AI module is further configured for translating translated tokenized text data representing the second user language to the tokenized text data representing the first user language, wherein the plurality of AI modules further comprises a text to speech AI module configured for generating a translated audio data corresponding to a translated user language from the audio data, wherein the presentation device comprises a display device configured to display each of the text data corresponding to the tokenized text data and the translated text data corresponding to the translated text data, wherein the presentation device comprises a speaker configured to present the translated audio data.

12. The real-time language translation system of claim 10, wherein the user input data comprises a plurality of user input data corresponding to a plurality of users, wherein the user language comprises a plurality of user languages corresponding to the plurality of user input data, wherein each of the plurality of user languages comprises a plurality of user dialects, wherein the plurality of AI modules further comprises at least one of a user ID AI model, a language ID AI model and a dialect ID AI model, wherein the user ID AI model is configured for generating a user ID data corresponding to each of the plurality of users based on the user input data, wherein the language ID AI model is configured for generating a user language ID data corresponding to each of the plurality of user languages based on the user input data, wherein the dialect ID AI model is configured for generating a user dialect ID data corresponding to each of the plurality of user dialects based on the user input data.

13. The real-time language translation system of claim 12, wherein the translation data comprises a GUI data configured for presenting a GUI on the presentation device, wherein the GUI data comprises a language detection button data corresponding to initiation of generating the user language ID data based on the language ID AI model.

14. The real-time language translation system of claim 1, wherein the user input data comprises an audio data corresponding to an audio input from the user, wherein the audio data comprises an audio characteristic data corresponding to a characteristic associated with the audio input, wherein the audio characteristic data comprises an audio energy level data corresponding to an energy level associated with the audio input, wherein the energy level further corresponds to a numerical value associated with the audio data.

15. The real-time language translation system of claim 1 further comprising a storage device configured for storing each of the user input data and the translation data associated with the user input data.

16. The real-time language translation system of claim 15 further comprises:
the storage device further configured for retrieving the user input data and the associated translation data; and
a communication device configured for transmitting each of the user input data and the translation data associated with the user input data to an external server.

17. The real-time language translation system of claim 13, wherein the translation data is presented on a user display device associated with the user device, wherein the user device comprises a user input device configured for receiving a feedback data corresponding to a feedback of the translation data, wherein the user device further comprises a user-processing device configured for generating a modified translation data based on the feedback data, wherein the user display device is further configured to present the modified translation data, wherein the generating is based on the AI model, wherein the communication device is further configured for receiving each of the feedback data and the modified translation data.

18. The real-time language translation system of claim 5, wherein the user comprises a plurality of users, wherein the GUI data comprises a user screen data corresponding to a screen presented on a user display device associated with the user device, wherein the user screen data comprises a multi button data corresponding to a plurality of buttons, wherein each of the plurality of buttons is associated with each of the plurality of users, wherein the user display device is further associated with the user device comprising a user input device configured for receiving a feedback data corresponding to a feedback corresponding to the multi button data, wherein the user device further comprises a user-processing device configured for generating a modified multi button data based on the feedback data, wherein the user display device is further configured to present the modified translation data.

19. A real-time language translation system embodied in a physical device, wherein the real-time language translation system comprises:
an input device configured for receiving generating a user input data representing a linguistic input from a user, wherein the linguistic input corresponds to a user language;
a processing device configured for generating a translation data based on the user input data, wherein the translation data represents a translation of the linguistic input, wherein the generating is based on an AI module, wherein the processing device is communicatively coupled to the input device; and
a presentation device configured for presenting the translation data, wherein the presentation device is communicatively coupled to the processing device, wherein the physical device is configured to be affixed on a user device associated with the user, wherein the physical device is configured to be communicatively coupled to the user device, wherein the physical device comprises at least one of a mobile case and an enclosed backpack.

20. A real-time language translation system embodied in a physical device, wherein the real-time language translation system comprises:
an input device configured for receiving generating a user input data representing a linguistic input from a user, wherein the linguistic input corresponds to a user language;
a processing device configured for generating a translation data based on the user input data, wherein the translation data represents a translation of the linguistic input, wherein the generating is based on an AI module, wherein the processing device is communicatively coupled to the input device; and
a presentation device configured for presenting the translation data, wherein the presentation device is communicatively coupled to the processing device; and
a storage device configured for storing each of the user input data and the translation data associated with the user input data.
